(19) United States
(12) Patent Application Publication
(10) Pub. No.: US 2015/0269177 A1
(43) Pub. Date: Sep. 24, 2015

(54) Method and system for determining user interest in a file

(71) Applicant: Ryan Louis Friedman, Laguna Hills, CA (US)

(72) Inventor: Ryan Louis Friedman, Laguna Hills, CA (US)

(21) Appl. No.: 14/222,731

(22) Filed: Mar. 24, 2014

(51) Int. Cl. G06F 17/30

(52) U.S. Cl. CPC G06F 17/30106; G06F 17/30091; G06F 17/30112

(57) ABSTRACT

A method and system for determining user interest in a file is disclosed. The method involves receiving a persistent command from a user to view a file, recording the duration of that persistent command, and determining a level of user interest based on the duration. Some embodiments also involve using the determined level of interest in social networking, using the determined level of interest for advertising or sales, and modifying the level of interest using statistical measures across multiple users or files.

### TECHNICAL FIELD

Embodiments disclosed herein relate generally to methods and systems for sharing digital content, and in particular to assessing user interest in digital content.

### BACKGROUND ART

The ability to determine the degree user interest content is increasingly important in Internet applications. Given accurate information concerning a user's preferences, advertisers can create bespoke enticements for every user, generating more revenue while reducing users' annoyance at poorly targeted advertisements. Merchants can sell to the users most likely to want their products. Social networking sites can collate users automatically into communities based upon common interests. Unfortunately, currently available techniques for determining a user's degree of interest in content are either ineffective or invasive. Perhaps the best known way of measuring user interest, by enumerating user selections of content (also known as “clicks”) is deeply flawed: a user can easily select content by accident, or select it and then ignore it. Worse, it is too easy for software or “click farms” full of professional content selectors to skew the data thus gathered. Likewise, methods that measure how long a file is open or even in the foreground of a computer's display can hardly guarantee that they are measuring user attention; perhaps a user has kept a particular image open for an hour not out of fascination, but because the user went grocery shopping and forgot to close the file. Programs that use digital cameras to track user eye movements achieve greater accuracy at the cost of a degree intrusion into users' private space that many users may find unacceptable.

Therefore, there remains a need for an accurate, non-invasive method for determining the degree of user interest in digital content.

### SUMMARY OF THE EMBODIMENTS

A method is disclosed for determining user interest in a file. The method includes receiving, by a computing device, at least one persistent command from a first user to view at least one file, recording, by the computing device, the duration of the at least one persistent command, and determining, by the computing device, a level of interest of the first user in the at least one file based upon the duration.

In a related embodiment of the method, receiving further includes receiving a repetitive command. In another embodiment, receiving also involves receiving a continuous command. In yet another embodiment, receiving the continuous command further involves displaying, to the first user, a representation of the at least one file, wherein the selection of the representation causes the file to display to the user only between a command initiating selection of the representation and a command completing selection of the representation, receiving, from the first user, a command initiating selection of the representation, and receiving, from the first user, a command completing selection of the representation.

In an additional embodiment, recording also includes recording a start time of the at least one persistent command, recording an end time of the at least one persistent command, and subtracting the start time from the end time. In another embodiment, recording also involves recording the duration of each of a plurality of persistent commands, and adding together the recorded durations. A further embodiment involves determining, by the computing device, that each of the plurality of persistent commands was a command to view the at least one file. An additional embodiment includes determining, by the computing device, that the first user issued each of the plurality of persistent commands.

In another embodiment, determining further involves obtaining additional indicia of the degree of interest of the first user in the at least one file and modifying the determined level of interest using the additional indicia. In a related embodiment, obtaining the additional indicia also includes enumerating the number of views of the at least one file by the first user. In another embodiment, obtaining the additional indicia further involves determining that an additional file has at least one feature in common with the at least one file and determining the level of interest of the first user in the additional file. Obtaining the additional indicia also involves receiving, from the first user, a recommendation of the at least one file to a second user, in an additional embodiment. In yet another embodiment, obtaining the additional indicia further includes receiving, from the first user, an explicit indication of degree of interest in the at least one file.

In another embodiment, determining involves determining, by the computing device, a plurality of levels of interest, where each level of interest is a level of interest of the first user in one of a plurality of files, and performing, by the computing device, a statistical calculation concerning the plurality of levels of interest. An additional embodiment involves providing, by the computing device, to a second user, the determined level of user interest. Another embodiment involves identifying, by the computing device, to the second user, the first user. An additional embodiment involves determining, by the computing device, based on the user's level of interest in the at least one file, a category of file in which the first user may have an interest, and providing, by the computing device, to the first user, at least one additional file belonging to the category. A related embodiment involves determining, by the computing device, the level of interest of the first user in the at least one additional file, and modifying, by the computing device, the determination of the category, based on the determined level of interest in the at least one additional file. Another embodiment of the method involves determining, by the computing device, a plurality of levels of interest, where each level of interest is the level of interest of one of a plurality of users in the at least one file, and performing, by the computing device, a statistical calculation concerning the plurality of levels of interest.

A system is also disclosed for determining user interest in a file, the system including a computing device, a user interface component, executing on the computing device, and configured to receive at least one persistent command from a first user to view at least one file and record the duration of the at least one persistent command, and an interest level calculator, executing on the computing device, and configured to determine a level of interest of the first user in the at least one file based upon the duration.

Other aspects, embodiments and features of the system and method will become apparent from the following detailed description when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the system and method shown where illustration is not necessary to allow those of ordinary skill in the art to understand the system and method.

### BRIEF DESCRIPTION OF THE DRAWINGS

The preceding summary, as well as the following detailed description of the disclosed system and method, will be better understood when read in conjunction with the attached drawings. It should be understood, however, that neither the system nor the method is limited to the precise arrangements and instrumentalities shown.

FIG. 1A is a schematic diagram depicting a computing device;

FIG. 1B is a schematic diagram depicting a network environment containing computing devices;

FIG. 2 is a schematic diagram depicting an embodiment of the disclosed system; and

FIG. 3 is a flow chart illustrating one embodiment of the disclosed method.

### DETAILED DESCRIPTION OF SPECIFIC EMBODIMENTS

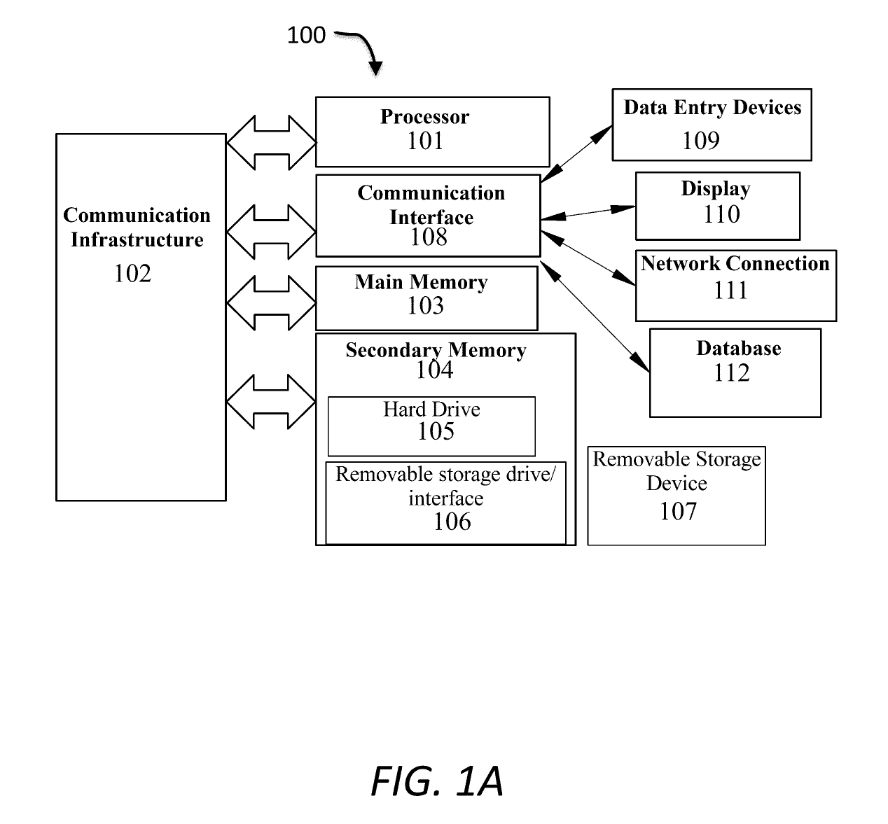

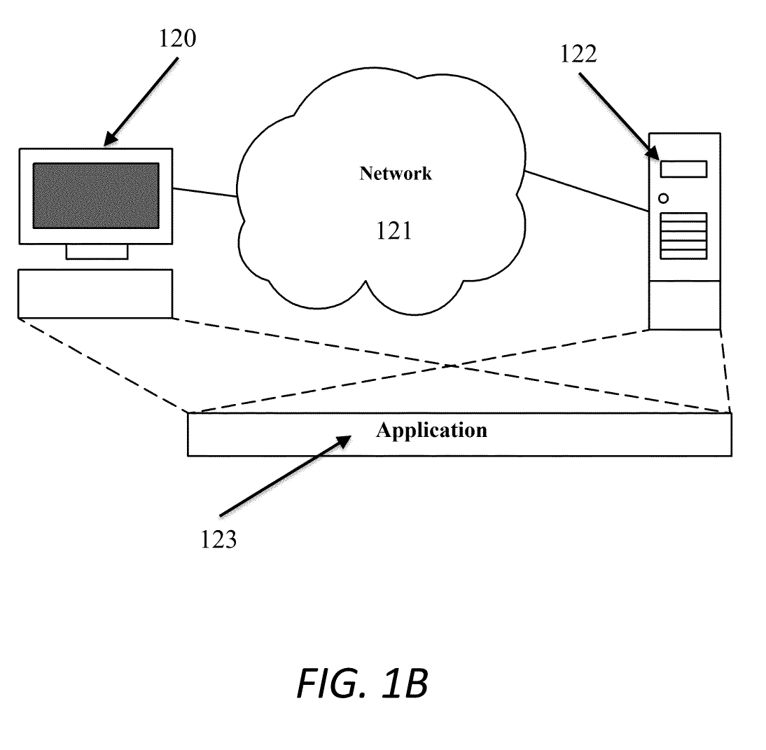

Some embodiments of the disclosed system and methods will be better understood by reference to the following comments concerning computing devices. A “computing device” may be defined as including personal computers, laptops, tablets, smart phones, and any other computing device capable of supporting an application as described herein. The system and method disclosed herein will be better understood in light of the following observations concerning the computing devices that support the disclosed application, and concerning the nature of web applications in general. An exemplary computing device is illustrated by FIG. 1A. The processor 101 may be a special purpose or a general-purpose processor device. As will be appreciated by persons skilled in the relevant art, the processor device 101 may also be a single processor in a multi-core/multiprocessor system, such system operating alone, or in a cluster of computing devices operating in a cluster or server farm. The processor 101 is connected to a communication infrastructure 102, for example, a bus, message queue, network, or multi-core message-passing scheme.

The computing device also includes a main memory 103, such as random access memory (RAM), and may also include a secondary memory 104. Secondary memory 104 may include, for example, a hard disk drive 105, a removable storage drive or interface 106, connected to a removable storage unit 107, or other similar means. As will be appreciated by persons skilled in the relevant art, a removable storage unit 107 includes a computer usable storage medium having stored therein computer software and/or data. Examples of additional means creating secondary memory 104 may include a program cartridge and cartridge interface (such as that found in video game devices), a removable memory chip (such as an EPROM, or PROM) and associated socket, and other removable storage units 107 and interfaces 106 which allow software and data to be transferred from the removable storage unit 107 to the computer system. In some embodiments, to “maintain” data in the memory of a computing device means to store that data in that memory in a form convenient for retrieval as required by the algorithm at issue, and to retrieve, update, or delete the data as needed.

The computing device may also include a communications interface 108. The communications interface 108 allows software and data to be transferred between the computing device and external devices. The communications interface 108 may include a modem, a network interface (such as an Ethernet card), a communications port, a PCMCIA slot and card, or other means to couple the computing device to external devices. Software and data transferred via the communications interface 108 may be in the form of signals, which may be electronic, electromagnetic, optical, or other signals capable of being received by the communications interface 108. These signals may be provided to the communications interface 108 via wire or cable, fiber optics, a phone line, a cellular phone link, and radio frequency link or other communications channels. Other devices may be coupled to the computing device 100 via the communications interface 108. In some embodiments, a device or component is “coupled” to a computing device 100 if it is so related to that device that the product or means and the device may be operated together as one machine. In particular, a piece of electronic equipment is coupled to a computing device if it is incorporated in the computing device (e.g. a built-in camera on a smart phone), attached to the device by wires capable of propagating signals between the equipment and the device (e.g. a mouse connected to a personal computer by means of a wire plugged into one of the computer's ports), tethered to the device by wireless technology that replaces the ability of wires to propagate signals (e.g. a wireless BLUETOOTH® headset for a mobile phone), or related to the computing device by shared membership in some network consisting of wireless and wired connections between multiple machines (e.g. a printer in an office that prints documents to computers belonging to that office, no matter where they are, so long as they and the printer can connect to the internet). A computing device 100 may be coupled to a second computing device (not shown); for instance, a server may be coupled to a client device, as described below in greater detail.

The communications interface in the system embodiments discussed herein facilitates the coupling of the computing device with data entry devices 109, the device's display 110, and network connections, whether wired or wireless 111. In some embodiments, “data entry devices” 109 is are any equipment coupled to a computing device that may be used to enter data into that device. This definition includes, without limitation, keyboards, computer mice, touchscreens, digital cameras, digital video cameras, wireless antennas, Global Positioning System devices, audio input and output devices, gyroscopic orientation sensors, proximity sensors, compasses, scanners, specialized reading devices such as fingerprint or retinal scanners, and any hardware device capable of sensing electromagnetic radiation, electromagnetic fields, gravitational force, electromagnetic force, temperature, vibration, or pressure. A computing device's “manual data entry devices” is the set of all data entry devices coupled to the computing device that permit the user to enter data into the computing device using manual manipulation. Manual entry devices include without limitation keyboards, keypads, touchscreens, track-pads, computer mice, buttons, and other similar components. A computing device may also possess a navigation facility. The computing device's “navigation facility” may be any facility coupled to the computing device that enables the device accurately to calculate the device's location on the surface of the Earth. Navigation facilities can include a receiver configured to communicate with the Global Positioning System or with similar satellite networks, as well as any other system that mobile phones or other devices use to ascertain their location, for example by communicating with cell towers.

In some embodiments, a computing device's “display” 109 is a device coupled to the computing device, by means of which the computing device can display images. Display include without limitation monitors, screens, television devices, and projectors.

Computer programs (also called computer control logic) are stored in main memory 103 and/or secondary memory 104. Computer programs may also be received via the communications interface 108. Such computer programs, when executed, enable the processor device 101 to implement the system embodiments discussed below. Accordingly, such computer programs represent controllers of the system. Where embodiments are implemented using software, the software may be stored in a computer program product and loaded into the computing device using a removable storage drive or interface 106, a hard disk drive 105, or a communications interface 108.

The computing device may also store data in database 112 accessible to the device. A database 112 is any structured collection of data. As used herein, databases can include “NoSQL” data stores, which store data in a few key-value structures such as arrays for rapid retrieval using a known set of keys (e.g. array indices). Another possibility is a relational database, which can divide the data stored into fields representing useful categories of data. As a result, a stored data record can be quickly retrieved using any known portion of the data that has been stored in that record by searching within that known datum's category within the database 112, and can be accessed by more complex queries, using languages such as Structured Query Language, which retrieve data based on limiting values passed as parameters and relationships between the data being retrieved. More specialized queries, such as image matching queries, may also be used to search some databases. A database can be created in any digital memory.

Persons skilled in the relevant art will also be aware that while any computing device must necessarily include facilities to perform the functions of a processor 101, a communication infrastructure 102, at least a main memory 103, and usually a communications interface 108, not all devices will necessarily house these facilities separately. For instance, in some forms of computing devices as defined above, processing 101 and memory 103 could be distributed through the same hardware device, as in a neural net, and thus the communications infrastructure 102 could be a property of the configuration of that particular hardware device. Many devices do practice a physical division of tasks as set forth above, however, and practitioners skilled in the art will understand the conceptual separation of tasks as applicable even where physical components are merged.

The systems may be deployed in a number of ways, including on a stand-alone computing device, a set of computing devices working together in a network, or a web application. Persons of ordinary skill in the art will recognize a web application as a particular kind of computer program system designed to function across a network, such as the Internet. A schematic illustration of a web application platform is provided in FIG. 1A. Web application platforms typically include at least one client device 120, which is an computing device as described above. The client device 120 connects via some form of network connection to a network 121, such as the Internet. The network 121 may be any arrangement that links together computing devices 120, 122, and includes without limitation local and international wired networks including telephone, cable, and fiber-optic networks, wireless networks that exchange information using signals of electromagnetic radiation, including cellular communication and data networks, and any combination of those wired and wireless networks. Also connected to the network 121 is at least one server 122, which is also an computing device as described above, or a set of computing devices that communicate with each other and work in concert by local or network connections. Of course, practitioners of ordinary skill in the relevant art will recognize that a web application can, and typically does, run on several servers 122 and a vast and continuously changing population of client devices 120. Computer programs on both the client device 120 and the server 122 configure both devices to perform the functions required of the web application 123. Web applications 123 can be designed so that the bulk of their processing tasks are accomplished by the server 122, as configured to perform those tasks by its web application program, or alternatively by the client device 120. Some web applications 123 are designed so that the client device 120 solely displays content that is sent to it by the server 122, and the server 122 performs all of the processing, business logic, and data storage tasks. Such “thin client” web applications are sometimes referred to as “cloud” applications, because essentially all computing tasks are performed by a set of servers 122 and data centers visible to the client only as a single opaque entity, often represented on diagrams as a cloud.

Many computing devices, as defined herein, come equipped with a specialized program, known as a web browser, which enables them to act as a client device 120 at least for the purposes of receiving and displaying data output by the server 122 without any additional programming. Web browsers can also act as a platform to run so much of a web application as is being performed by the client device 120, and it is a common practice to write the portion of a web application calculated to run on the client device 120 to be operated entirely by a web browser. Such browser-executed programs are referred to herein as “client-side programs,” and frequently are loaded onto the browser from the server 122 at the same time as the other content the server 122 sends to the browser. However, it is also possible to write programs that do not run on web browsers but still cause an computing device to operate as a web application client 120. Thus, as a general matter, web applications 123 require some computer program configuration of both the client device (or devices) 120 and the server 122. The computer program that comprises the web application component on either computing device's system FIG. 1A configures that device's processor 200 to perform the portion of the overall web application's functions that the programmer chooses to assign to that device. Persons of ordinary skill in the art will appreciate that the programming tasks assigned to one device may overlap with those assigned to another, in the interests of robustness, flexibility, or performance. Furthermore, although the best known example of a web application as used herein uses the kind of hypertext markup language protocol popularized by the World Wide Web, practitioners of ordinary skill in the art will be aware of other network communication protocols, such as File Transfer Protocol, that also support web applications as defined herein.

Embodiments of the disclosed system and methods determine the degree of user interest in electronic files by measuring the time a user spends actively working to make the file display. As persistent user input pertaining to a file is very likely to coincide with the user's interest in exploring the file's contents, the times thus captured may provide a very useful metric of user interest. Some embodiments incorporate the measurement of user interest with social networks, sharing users' honest opinions on their behalves. Other embodiments use the determination of user interest to assess the popularity of content, while others still apply the data thus gather to more effective sales and advertising.

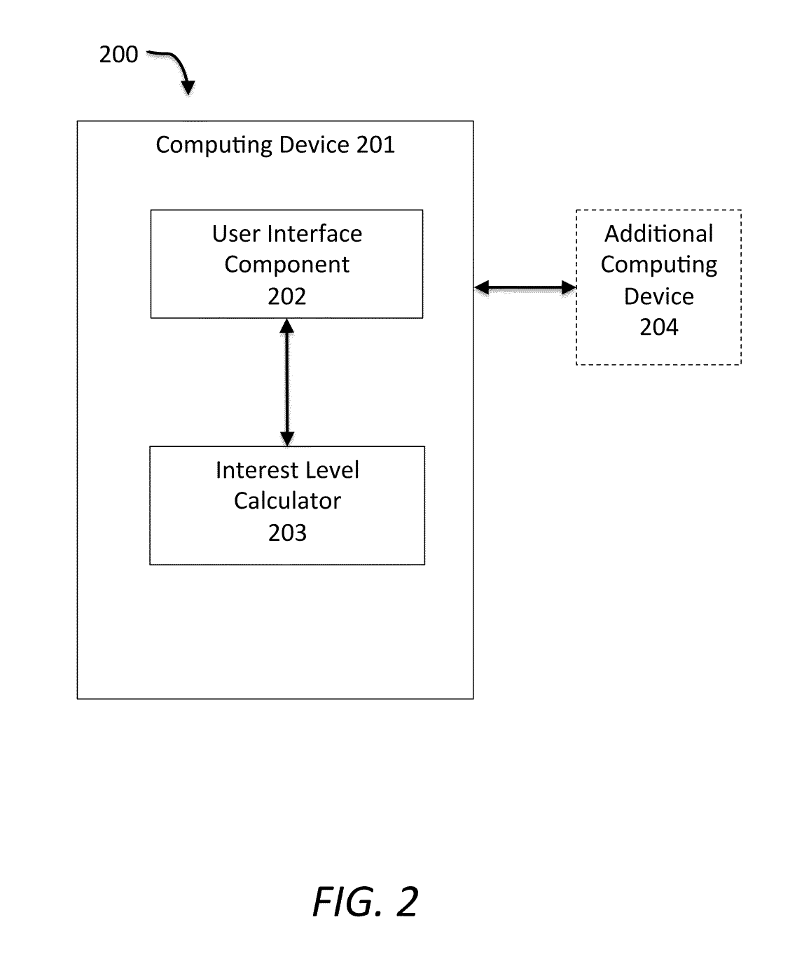

FIG. 2 depicts a system 200 for determining user interest in a file. As an overview, the system includes a computing device 201. Executing on the computing device 201 is a set of algorithmic steps that may be conceptually described as creating a user interface component 202 and an interest level calculator 203. The organization of tasks into those two components solely reflects a categorization of the tasks to be performed, and does not dictate the architecture of particular implementations of the system 200. For instance, in some embodiments of the system 200, various objects in an object-oriented language execute the performed steps, but the objects divide the tasks in a different manner than the above division. In other embodiments, the algorithmic steps exist as a set of instructions in a non-object oriented language, with no explicit separation of responsibility for steps into distinct components at all. Persons skilled in the art will recognize the existence of a broad variety of programming approaches that could cause the computing device 201 to perform the algorithmic steps.

Embodiments of the disclosed system and method involve the manipulation of electronic files. In some embodiments, electronic files, also referred to as “files,” are sets of data stored persistently in memory coupled to a computing device, such as a computing device 100 as described above in reference to FIGS. 1A-1B. In some embodiments, the data associated with a particular file are stored, retrieved, and manipulated in concert, creating an effect for the user analogous to that of retrieving and viewing a paper file. The data in a file may be stored in the form of bytes; for example, the file may be manipulated by the computing device as an array of bytes. The data in the file may be portrayed to a user by data output devices coupled to the computing device, as dictated by the formatting convention associated with the file. For instance, a file that the computing device 201 identifies as containing an image, such as a Joint Photographic Experts Group (“JPEG”) file, may be provided to an end user as an image depicted on the display of the computing device, in which the color, brightness, and other attributes of each pixel in the image is determined by the computing device's interpretation of the data stored in the file. Likewise, data from a file identified by the computing device as containing audio data, such as a Moving Pictures Experts Group—Audio Layer III (MP3) file, may be provided to the user in the form of sound produced via by a speaker coupled to the computing device. A file may be an executable file, containing instructions for the computing device to execute, such as a computer program as described above in reference to FIGS. 1A-1B; for example, the executable may be a computer game. In some embodiments, two files are the same file if their contents are substantially identical.

Embodiments of the disclosed system and method involve social networks. A social network may be any facility connected to a network that establishes connections from one user to at least another user based upon the relationship between the users. The relationship may be based solely upon an invitation from one user to another to connect. The relationship may be based upon a familial relationship. The relationship may be based upon a romantic relationship. The relationship may be based upon a collegial relationship. Some users of social networks are connected to each other by virtue of attendance at a common educational institution. Some users of social networks are connected to each other by virtue of attendance at a common religious institution. Each user of a social network has a user account that lists that user's connections. The user account may also provide information identifying the user. The user account may include the user's name. The user account may include the user's occupation. The user account may include the user's geographical location. The user account also may contain a mechanism by means of which the user may be contacted. In some cases, the user account only permits contact via the social network, from users connected to the user. In some cases, the user account only permits contact via the social network, but that contact is open to users who are not connected to the user. In some cases, the user account lists direct contact information such as an electronic mail address. The social network may permit users to share files with each other. The social network may permit users to provide feedback and comments to each other concerning shared content.

Referring to FIG. 2 in more detail, the system 200 includes a computing device 201. In some embodiments, the computing device 201 is a computing device 100 as disclosed above in reference to FIG. 1A. In other embodiments, the computing device 201 is a set of computing devices 100, as discussed above in reference to FIG. 1A, working in concert; for example, the computing device 201 may be a set of computing devices in a parallel computing arrangement. The computing device 201 may be a set of computing devices 100 coordinating their efforts over a private network, such as a local network or a virtual private network (VPN). The computing device 201 may be a set of computing devices 100 coordinating the efforts over a public network, such as the Internet. The division of tasks between computing devices 100 in such a set of computing devices working in concert may be a parallel division of tasks or a temporal division of tasks; as an example, several computing devices 100 may be working in parallel on components of the same tasks at the same time, where as in other situations one computing device 100 may perform one task then send the results to a second computing device 100 to perform a second task. In one embodiment, the computing device 201 is a server 122 as disclosed above in reference to FIG. 1B. The computing device 201 may communicate with one or more additional servers 122. The computing device 201 and the one or more additional servers 122 may coordinate their processing to emulate the activity of a single server 122 as described above in reference to FIG. 1B. The computing device 201 and the one or more additional servers 122 may divide tasks up heterogeneously between devices; for instance, the computing device 201 may delegate the tasks of the user interface component 202 to an additional server 122. In some embodiments, the computing device 201 functions as a client device 120 as disclosed above in reference to FIG. 1B.

The user interface component 202 executes on the computing device 201. The user interface component 202 in some embodiments is a computer program as described above in reference to FIGS. 1A and 1B. In some embodiments, the user interface component 202 is configured to receive at least one persistent command from a first user to view at least one file and to record the duration of the at least one persistent command. In some embodiments, the user interface component communicates with the display and data entry devices of the computing device 201, as described above in reference to FIG. 1A. In other embodiments, the user interface component 202 receives user input via an additional computing device 204; as an example, the user interface component may communicate with an application running on the additional computing device 204, and the application in turn may interact with the user via the display and data entry devices coupled to the additional computing device 204. In other embodiments, the user interface component 204 communicates with a client-side counterpart on the additional computing device 204 as described above in reference to FIG. 1B.

The interest level calculator 203 executes on the computing device 201. The interest level calculator 203 in some embodiments is a computer program as described above in reference to FIGS. 1A and 1B. In some embodiments, the interface component 202 is configured to determine a level of interest of the first user in the at least one file based upon the duration of a persistent command to view the file.

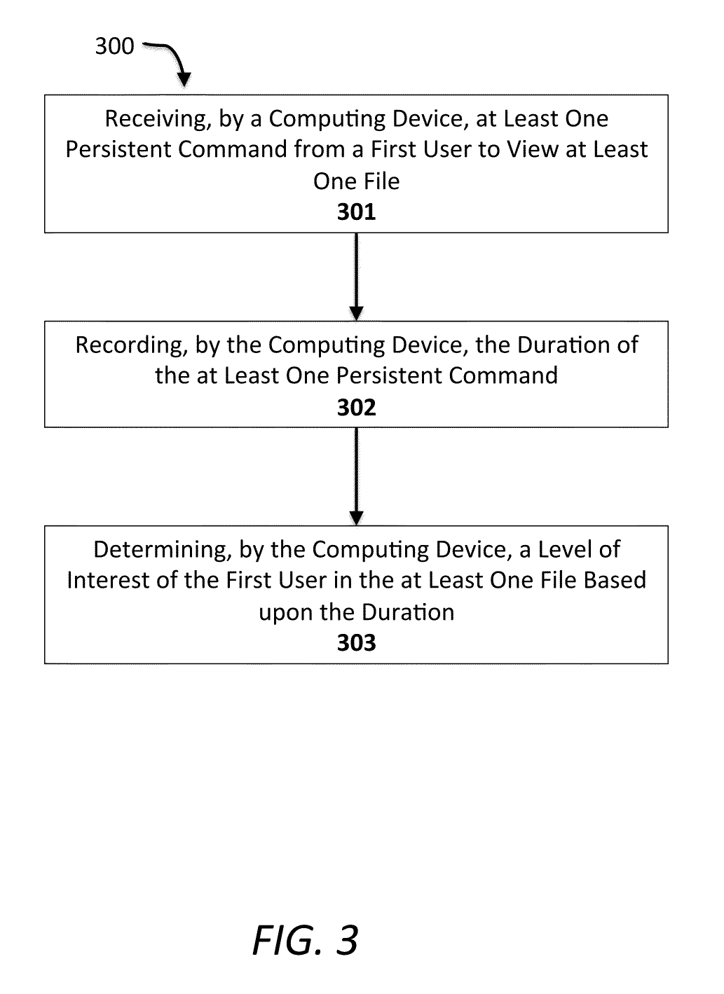

FIG. 3 illustrates some embodiments of a method 300 for determining user interest in a file. The method 300 includes receiving, by a computing device, at least one persistent command from a first user to view at least one file (301). The method includes recording, by the computing device, the duration of the at least one persistent command (302). The method 300 includes determining, by the computing device, a level of interest of the first user in the at least one file based upon the duration (303).

Referring to FIG. 3 in greater detail, and by reference to FIG. 2, the user interface component 202 receives at least one persistent command from a first user to view at least one file (301). In one embodiment, receiving a persistent command to view a file involves receiving a stream of user inputs that together demonstrate the user's continuing intent to view the file. The user interface component 202 may continue to display the file to the user only during the duration of the at least one persistent command. In some embodiments, receiving involves receiving a repetitive command, wherein the user repeatedly enters a command to keep the file open. For instance, the user interface component 202 may continue to display the file to the user only if the user repeatedly taps a key with more than a threshold frequency. The user interface component 202 may continue to display the file to the user only if the user presses a button with more than a threshold frequency. The user interface component 202 may continue to display the file to the user only if the user repeatedly taps a touchscreen with more than a threshold frequency.

In other embodiments, receiving involves receiving a continuous command, wherein a user actively engages with one or more data entry devices to continuously manifest the user's continued desire to view the file. For instance, the user interface component 202 may continue to display the file to the user only if the user holds down a mouse button. The user interface component 202 may continue to display the file to the user only if the user holds down a key. The user interface component 202 may continue to display the file to the user only if the user continues to press a finger against a touchscreen. In some embodiments, receiving the continuous command further involves displaying, to the first user, a representation of the at least one file the selection of which causes the file to display to the user only between a command initiating selection of the representation and a command completing selection of the representation, receiving, from the first user, a command initiating selection of the representation, and receiving, from the first user, a command completing selection of the representation. As an example, the user interface component 202 may display a thumbnail corresponding to an image to the user; when the user initiates selection, for example by positioning the mouse cursor over the thumbnail and depressing the mouse button, or by pressing a finger against the thumbnail on a touchscreen, the user interface component 202 may display the file to the user until the user releases the mouse button or stops pressing the screen, respectively. The thumbnail may correspond to a video or audio file that will play only as long as the user depresses the button or continues to press against the touchscreen.

The user interface component 202 records the duration of the at least one persistent command (302). In some embodiments, the user interface component 202 records the duration of the at least one persistent command by recording a start time of the at least one persistent command, recording an end time of the at least one persistent command, and subtracting the start time from the end time. For example, where the user initiated the persistent command by pressing a finger on a thumbnail corresponding to the file, and ended the persistent command by releasing the finger from the touchscreen, the user interface component 202 may record the duration of the persistent command as the time that elapsed between the user pressing the thumbnail and the user releasing the thumbnail. In some embodiments, the at least one persistent command is a plurality of persistent commands, and the user interface component 202 records the duration of the at least one persistent command by recording the duration of each of a plurality of persistent commands, and adding together the recorded durations. In some embodiments, the user interface component 202 determines that each of the plurality of persistent commands was a command to view the same file. In one embodiment, the user interface component 202 determines that the file was the same because each command pertained to the same copy of the file. For instance, the user interface component 202 may determine that each command was a command to view a file in the same location in memory; for instance, each command could pertain to the same memory location on the computing device 210. Each command could pertain to the same memory location on a client device 120 used by the first user as described above in reference to FIG. 1B. Each command could pertain to the same memory location on a remote device 122 storing the file, as described above in reference to FIG. 1B.

In other embodiments, the user interface component 202 determines that two files stored in different locations are the same file because they have identical contents. As an example, each file may have a unique identifier that is copied whenever the file is copied, which the user interface component 202 uses to identify the file. Each file may have a set of metadata that is copied with the file, which the user interface component 202 uses to identify the file. The metadata may include a time. The metadata may include the time the file was created; for instance, the metadata for a digital photograph may include the time and date on which the photograph was taken. The metadata may include the time a file was uploaded to a particular computing device, such as the computing device 210 or another device 122 working in concert with the computing device. The metadata may include the time a file was commented on. The metadata may include a geographical location. The metadata may include the geographical location at which the file was created; for example, where the file is a digital photograph, the metadata may include the geographical location at which the photograph was taken. In one embodiment, the geographical location is determined by a navigation facility, such as the navigation facility coupled to the device that took a digital photograph or video. In another embodiment the geographical location is determined according to the known location of a computing device. For instance, the computing device that created the file may have a known location. The computing device may have an approximate known location. In some embodiments, the location is the location of a server 122 operating on the system including the computing device 210. The metadata may include the identity of a user; the identified user may be a user that created the file. The identified user may be a user that uploaded the file. The identified user may be a user that commented on the file.

In some embodiments, the user interface component 202 determines that the first user issued each of the plurality of persistent commands. In some embodiments, the first user has an identifier that identifies the first user; for instance, the first user may have an account on a social network, and the account may include a user identifier that the user interface component 202 may use to identify the first user. The first user may have an identifier that associates the first user with a particular computing device; for instance, the first user may have a mobile phone that is identified as the first user's mobile phone. As another example, the first user may log onto the computing device the first user is using with an identifier the user interface component 202 can use to identify the first user. In some embodiments, a computing device being used by the first user captures information that may be used to identify the first user; for instance, the computing device used by the first user may capture an image of the first user by means of a digital camera coupled to the computing device used by the first user. The computing device used by the first user may capture a biometric sample identifying the first user; for instance, the computing device used by the first user may have a fingerprint reader that determines the identity of the user making physical contact with the computing device used by the first user.

The method 300 includes determining, by the computing device, a level of interest of the first user in the at least one file based upon the duration (303). In some embodiments, the interest level calculator maps the duration of the at least one persistent command to a set of grades for the degree of interest. For instance, the interest level calculator 203 may assign a score of 0 to a duration less than 1.5 seconds, a score of 0.1 to a duration of between 1.5 and 4 seconds, a score of 0.15 to a duration of between 4 and 6 seconds, and a score of 0.2 for a duration between 6 and 8 seconds. The interest level calculator 203 may also translate the graded score into verbal descriptions. For instance, for a score of 0.1, the interest level calculator 203 might create a description stating that the first user “liked” the file. For a score of 0.15, the interest level calculator 203 might create a description stating that the first user “really liked” the file. For a score of 0.2, the interest level calculator 203 might create a description stating that the first user “loved” the file. In some embodiments, the interest level calculator 203 bases the calculated interest level on both the duration of the persistent command and the type of file; for instance, sufficient viewing time to indicate a high degree of interest in a video may be much longer than the viewing time necessary to indicate a high level of interest in a photograph.

In some embodiments, interest level calculator 203 additionally determines the first user's level of interest in the file by obtaining additional indicia of the degree of interest of the first user in the at least one file and modifying the determined level of interest using the additional indicia. Obtaining the additional indicia may include enumerating the number of views of the at least one file by the first user. The enumeration of the number of views of the at least one file by the first user may also include collation of the degree of interest indicated by the user during each view; the interest level calculator 203 may modify the level of interest to match the average level of interest. The interest level calculator 203 may modify the level of interest to match the peak level of interest. In some embodiments, the interest level calculator 203 may create a measure of the first user's level of interest that incorporates the fact of the first user's multiple viewings; for instance, the interest level may be a data structure containing at least two numbers, one tracking the first user's level of interest as determined by persistent command duration, and one tracking the number of views of the file by the first user. The interest level calculator 203 may create a description that accounts for the number of views of the at least one file by the first user; for instance, the interest level calculator 203 may create a description stating that the first user viewed the at least one file a certain number of times. The interest level calculator 203 may create a description that indicates both the interest level as determined by persistent command duration and the number of views. Thus, the interest level calculator 203 may create a description that indicates that the first user viewed the at least one file multiple times and on each occasion loved the file.

In some embodiments, the interest level calculator 203 obtains the additional indicia by determining that an additional file has at least one feature in common with the at least one file and determining the level of interest of the first user in the additional file. In some embodiments, the interest level calculator 203 obtains the additional indicia by receiving, from the first user, a recommendation of the at least one file to a second user. For instance, the first user may forward the file to another user. In other embodiments, the interest level calculator 203 obtains the additional indicia by receiving, from the first user, an explicit indication of degree of interest. For instance, the first user may select an indicator the selection of which indicates a user's degree of interest in the file. The selection of the indicator may indicate approval, as in a “like” button. The selection of the indicator may indicate disapproval, as in a “dislike” button. The first user may enter a comment that indicates the first user's level of interest; the interest level calculator 203 may parse the comment for words or phrases associated with positive or negative reactions. The interest level calculator 203 may determine additional interest level scores or indicators that account for conflicting indications of interest. For instance, if the first user indicates explicitly that the first user does not approve of a file, but the duration of persistent commands and number of views indicates a high level of interest, the interest level calculator 203 may produce a score or description indicating a mixed emotion such as horrified fascination.

Some embodiments of the method 300 involve providing, by the computing device 210, to a second user, the determined level of user interest. The user interface device 202 may provide a graded indication calculated by the interest level calculator 203 as described above. The user interface device 202 may provide a description, created by the interest level calculator 203 as set forth above in reference to FIG. 3, describing the first user's level of interest. In some embodiments, the user interface component 202 also identifies the first user to the second user. As an example, the user interface component 202 may display a message to the second user stating that the first user really liked the second user's photograph.

In some embodiments, the interest level calculator 203 determines a plurality of levels of interest, where each level of interest is the level of interest of the first user in one of a plurality of files, and performs a statistical calculation concerning the plurality of levels of interest. The interest level calculator 203 may determine the level of interest of the first user in each of the plurality of files by any process described above in reference to FIG. 3. For instance, the interest level calculator 203 may determine the average degree of interest the first user has in a typical file. The interest level calculator 203 may compare that average level of interest to the level of interest of the first user in an individual file; for example, the interest level calculator 203 may scale the level of interest for an individual file by the level of interest the first user has for a typical file, so that the first user does not skew the interest level calculations simply by taking a longer time than other users to view every file. The interest level calculator 203 may account for the contents of files in performing the statistical calculation. For instance, in some embodiments, the interest level calculator 203 determines, based on the user's level of interest in the at least one file, a category of file in which the first user may have an interest; the at least one file the interest level calculator 203 evaluates may be a plurality of files. The category may be based upon the genera of content; for instance, the first user may be especially interested in a particular kind of music or film. The category may be based on persons included in the file; for instance, the first user may prefer a particular actor in a movie. The first user may prefer a particular person in a photograph.

In some embodiments, the interest level calculator 203 determines, based on the user's level of interest in the at least one file, a category of file in which the first user may have an interest, and provides at least one additional file belonging to the category to the first user. For example, the user interface component 202 may present the first user one or more additional files as “recommendations” based on the first user's past viewing. In some embodiments, the interest level calculator 203 determines the level of interest of the first user in the at least one additional file and modifies the determination of the category based on the determined level of interest in the at least one additional file. The interest level calculator 203 may determine the first user's level of interest in the at least one additional file by any algorithm described above in reference to FIG. 3. If, for example, the first user has a lower level of interest in the at least one additional file, the interest level calculator 203 may refine the category by excluding from the category a feature that the at least one additional file and the at least one file do not have in common; for instance, the category, based on the at least one file, may be film noir, but the at least one additional file may be a film noir containing Humphrey Bogart, causing the category to change to film noir excluding Humphrey Bogart. If the first user has a higher level of interest in the at least one additional file, the interest level calculator 203 may refine the category by including in the category a feature that the at least one additional file and the at least one file do not have in common; for instance, the category, based on the at least one file, may be film noir, but the at least one additional file may be a film noir directed by Orson Welles, causing the category to change to film noir directed by Orson Welles.

In some embodiments, the interest level calculator 203 determines a plurality of levels of interest, where each level of interest is the level of interest of one of a plurality of users in the at least one file, and performs a statistical calculation concerning the plurality of levels of interest. The interest level calculator 203 may determine each level of interest in the plurality using any approach for determining a level of interest as described above in reference to FIG. 3. In some embodiments, the interest level calculator 203 selects the plurality of users randomly. In some embodiments, the interest level calculator 203 selects the plurality of users from a set of users sharing at least one characteristic; for instance, the plurality of users might be males between the ages of 18 and 35. The at least one characteristic may be one shared by the first user. The interest level calculator 203 may determine the average degree of interest a user from the plurality of users has in a particular file. The interest level calculator 203 may determine the average degree of interest a user from the plurality of users has in a particular category of file. In some embodiments, the interest level calculator 203 scales the level of interest of the first user in the at least one file by an average level of interest of the plurality of users in the at least one file.

It will be understood that the system and method may be embodied in other specific forms without departing from the spirit or central characteristics thereof. The present examples and embodiments, therefore, are to be considered in all respects as illustrative and not restrictive, and the system method is not to be limited to the details given herein.

What is claimed is:

1. A method for determining user interest in a file, the method comprising:
receiving, by a computing device, at least one persistent command from a first user to view at least one file;
recording, by the computing device, a duration of the at least one persistent command; and
determining, by the computing device, a level of interest of the first user in the at least one file based upon the duration.

2. A method according to claim 1, wherein receiving further comprises receiving a repetitive command.

3. A method according to claim 1, wherein receiving further comprises receiving a continuous command.

4. A method according to claim 3, wherein receiving the continuous command further comprises:
displaying, to the first user, a representation of the at least one file, wherein selection of the representation causes the file to display to the user only between a command initiating selection of the representation and a command completing selection of the representation;
receiving, from the first user, a command initiating selection of the representation; and
receiving, from the first user, a command completing selection of the representation.

5. A method according to claim 1, wherein recording further comprises:
recording a start time of the at least one persistent command;
recording an end time of the at least one persistent command; and
subtracting the start time from the end time.

6. A method according to claim 1, wherein recording further comprises recording the duration of each of a plurality of persistent commands, and adding together the recorded durations.

7. A method according to claim 6, further comprising determining, by the computing device, that each of the plurality of persistent commands was a command to view the at least one file.

8. A method according to claim 6 further comprising determining, by the computing device, that the first user issued each of the plurality of persistent commands.

9. A method according to claim 1 wherein determining further comprises
obtaining additional indicia of the degree of interest of the first user in the at least one file; and
modifying the determined level of interest using the additional indicia.

10. A method according to claim 9, wherein obtaining the additional indicia further comprises enumerating the number of views of the at least one file by the first user.

11. A method according to claim 9, wherein obtaining the additional indicia further comprises:
determining that an additional file has at least one feature in common with the at least one file; and
determining the level of interest of the first user in the additional file.

12. A method according to claim 9, wherein obtaining the additional indicia further comprises receiving, from the first user, a recommendation of the at least one file to a second user.

13. A method according to claim 9, wherein obtaining the additional indicia further comprises receiving, from the first user, an explicit indication of degree of interest in the at least one file.

14. A method according to claim 1, where determining further comprises:
determining, by the computing device, a plurality of levels of interest, where each level of interest is a level of interest of the first user in one of a plurality of files; and
performing, by the computing device, a statistical calculation concerning the plurality of levels of interest.

15. A method according to claim 1, further comprising:
determining, by the computing device, based on the user's level of interest in the at least one file, a category of file in which the first user may have an interest; and
providing, by the computing device, to the first user, at least one additional file belonging to the category.

16. A method according to claim 15, further comprising:
determining, by the computing device, the level of interest of the first user in the at least one additional file; and
modifying, by the computing device, the determination of the category, based on the determined level of interest in the at least one additional file.

17. A method according to claim 1, further comprising providing, by the computing device, to a second user, the determined level of user interest.

18. A method according to claim 17, further comprising identifying, by the computing device, to the second user, the first user.

19. A method according to claim 1 further comprising:
determining, by the computing device, a plurality of levels of interest, where each level of interest is the level of interest of one of a plurality of users in the at least one file; and
performing, by the computing device, a statistical calculation concerning the plurality of levels of interest.

20. A system for determining user interest in a file, the system comprising:
a computing device;
a user interface component, executing on the computing device, and
configured to receive at least one persistent command from a first user to view at least one file and to record the duration of the at least one persistent command; and
an interest level calculator, executing on the computing device, and configured to determine a level of interest of the first user in the at least one file based upon the duration.
